(19) United States
(12) Patent Application Publication
(10) Pub. No.: US 2024/0428171 A1
(43) Pub. Date: Dec. 26, 2024

(54) TARGETED KEY PERFORMANCE INDICATOR IMPACT ALERTS

(71) Applicant: International Business Machines Corporation, Armonk, NY (US)

(72) Inventors: Neelamadhav Gantayat, Bengaluru (IN); Avirup Saha, Kolkata (IN); Renuka Sindhgatta Rajan, Bengaluru (IN); SAMPATH DECHU, Acton, MA (US); Dharma Teja Atluri, Hyderabad (IN); Sambit Ghosh, Kolkata (IN)

(21) Appl. No.: 18/341,236

(22) Filed: Jun. 26, 2023

(51) Int. Cl. G06Q 10/0639; H04L 51/04; H04L 51/216

(52) U.S. Cl. CPC G06Q 10/06393; H04L 51/04; H04L 51/216

(57) ABSTRACT

A method including employing corporate data to generate an acyclic graph representing a reporting hierarchy, identifying relevant key performance indicators (KPIs) for a plurality of users, training a classifier to predict whether a KPI is relevant to a user of the plurality of users, generating interest-persona maps correlating KPI impact alerts with a subset of the plurality of users based on detected information technology (IT) event streams, business streams, KPI streams, and environmental metrics streams, assigning a score to each KPI impact alert based on compatibility between user features and KPI features, and notifying, by consulting the interest-persona maps, one or more targeted users of the KPI impact alerts relevant to them.

### BACKGROUND

The present invention relates generally to alert monitoring methods and systems, and more specifically, to targeted key performance indicator (KPI) impact alerts.

Today's large-scale Information Technology (IT) systems encompass multiple data centers, geographical locations, and diverse hardware and software platforms. Services are no longer confined to racks within a single data center. Instead, they may often be deployed and served from multiple locations. The management of large-scale IT infrastructure is becoming the focus for data center optimization and innovation. Within the area of service management, incident management is a main target for optimization because it is often a major portion of the work performed by the System Administrators (SAs) managing the system components. Other service management tasks include problem, change, and patch management.

Efficient management of IT operations and facilities is a major competitive advantage for service providers, given the massive scale and costs involved with today's IT service delivery infrastructures. In these environments, massive physical infrastructures (networking, power, cooling, security) exist to deploy and manage data centers, as well as run applications for different clients. System and application incidents and failures occur almost 24 hours a day, 7 days a week.

Therefore, ideally, an incident management framework should be in place to respond to them in a timely manner and in accordance with customer Service Level Agreements (SLAs) and service delivery Service Level Objectives (SLOs). Proactive prevention and in-time response to failures with minimal operational costs is a major target for service providers. Proactive actions are usually enabled by the use of monitoring tools that allow SAs to observe in real-time the performance and status of the management components through sampling of Key Performance Indicators (KPIs). When KPI variation indicates that a managed component is in or approaching a state that would lead to an SLA or SLO violation, notification messages, called alerts, are automatically generated and sent to an SA.

Alerts may be delivered by, for example, electronic mail messages or incident tickets in the Incident Management tools, or other means. The generation of monitoring alerts is usually determined by the monitoring policy deployed on the managed server. The policy may include one or more monitoring rules that describe conditions involving KPIs, processes, and other system operation components. Generally, alerts are generated when the conditions in the monitoring rules hold true. Sometimes, false positive alerts may be generated. A false positive is an alert that has been generated, for example, when the conditions in the monitoring rules hold true, even though the monitored system is performing properly and no SLA/SLO failure exists. An SA's time is not efficiently spent if he/she has to handle false-positive alerts. To reduce the number of alerts, in general, and of false alerts, monitoring rules usually need to be customized for fine details of the workload running on the managed systems.

In large-scale IT systems, substantial resources are usually required for managing the monitoring systems and for serving the monitoring alerts generated by these systems. Depending on the size and complexity, managing the IT infrastructure's operations can cost companies billions of dollars. Incident management systems handle the logging of monitoring alerts and incidents, dispatching them to appropriate system operators, and tracking their resolution. However, it is unclear which users or individuals within the organization need to be notified of which business KPIs.

### SUMMARY

In accordance with an embodiment, a method is provided. The method includes employing corporate data to generate an acyclic graph representing a reporting hierarchy, identifying relevant key performance indicators (KPIs) for a plurality of users, training a classifier to predict whether a KPI is relevant to a user of the plurality of users, generating interest-persona maps correlating KPI impact alerts with a subset of the plurality of users based on detected information technology (IT) event streams, business streams, KPI streams, and environmental metrics streams, assigning a score to each KPI impact alert based on compatibility between user features and KPI features, and notifying, by consulting the interest-persona maps, one or more targeted users of the KPI impact alerts relevant to them.

In accordance with another embodiment, a computer program product for implementing a key performance indicator (KPI) identification and mapping system is provided, the computer program product comprising a computer readable storage medium having program instructions embodied therewith. The program instructions are executable by a computer to cause the computer to employ corporate data to generate an acyclic graph representing a reporting hierarchy, identify relevant key performance indicators (KPIs) for a plurality of users, train a classifier to predict whether a KPI is relevant to a user of the plurality of users, generate interest-persona maps correlating KPI impact alerts with a subset of the plurality of users based on detected information technology (IT) event streams, business streams, KPI streams, and environmental metrics streams, assign a score to each KPI impact alert based on compatibility between user features and KPI features, and notify, by consulting the interest-persona maps, one or more targeted users of the KPI impact alerts relevant to them.

In accordance with yet another embodiment, a system for implementing a key performance indicator (KPI) identification and mapping architecture is provided. The system includes a memory and one or more processors in communication with the memory configured to employ corporate data to generate an acyclic graph representing a reporting hierarchy, identify relevant key performance indicators (KPIs) for a plurality of users, train a classifier to predict whether a KPI is relevant to a user of the plurality of users, generate interest-persona maps correlating KPI impact alerts with a subset of the plurality of users based on detected information technology (IT) event streams, business streams, KPI streams, and environmental metrics streams, assign a score to each KPI impact alert based on compatibility between user features and KPI features, and notify, by consulting the interest-persona maps, one or more targeted users of the KPI impact alerts relevant to them.

In one preferred aspect, the corporate data includes at least IT tickets, emails from an email communication program, and instant messages from an instant messaging communication program between the plurality of users of a corporation.

In another preferred aspect, a user sequence is extracted from the IT tickets.

In yet another preferred aspect, a recipient user sequence is extracted from the emails having an email chain with a same or related subject line.

In one preferred aspect, a user mention sequence is extracted from the instant messages having a common conversation thread.

In another preferred aspect, the user sequence, the recipient user sequence, and the user mention sequence are merged to generate the acyclic graph representing the reporting hierarchy.

In yet another preferred aspect, the acyclic graph representing the reporting hierarchy is compared with an existing organization chart for job profile consistency.

In one preferred aspect, the score of each KPI impact alert increases with duration and severity of KPI impact.

In another preferred aspect, the one or more targeted users are notified based on seasonality information.

In yet another preferred aspect, the one or more targeted users are notified based geographical locations.

The advantages of the present invention include providing targeted or focused KPI impact alerts to specific or targeted or appropriate users within the business or organization. One of the most important aspects of a business has always been KPIs. Without KPIs, a company runs the danger of losing business due to unpredictable performance or management issues. An important factor in enabling managers and members of the team to stay on track to meet and exceed the company's goals and objectives is selecting the right KPIs and linking such KPIs quickly and effectively to the appropriate users within the organization. Effective and targeted KPI reporting to appropriate users is important because it provides an explicit and accurate picture of a business's performance, well-being, and growth potential. Using several specific KPIs and forwarding specific KPI alerts to appropriate users is a far better solution for measuring business growth and success than simply basing it on one measurement, such as annual revenue.

It should be noted that the exemplary embodiments are described with reference to different subject-matters. In particular, some embodiments are described with reference to method type claims whereas other embodiments have been described with reference to apparatus type claims. However, a person skilled in the art will gather from the above and the following description that, unless otherwise notified, in addition to any combination of features belonging to one type of subject-matter, also any combination between features relating to different subject-matters, in particular, between features of the method type claims, and features of the apparatus type claims, is considered as to be described within this document.

These and other features and advantages will become apparent from the following detailed description of illustrative embodiments thereof, which is to be read in connection with the accompanying drawings.

### BRIEF DESCRIPTION OF THE DRAWINGS

The invention will provide details in the following description of preferred embodiments with reference to the following figures wherein:

FIG. 1 is a block/flow diagram providing a comparison between conventional key performance indicator (KPI) systems and the exemplary targeted KPI impact alert system, in accordance with an embodiment of the present invention;

FIG. 2 is a block/flow diagram of an exemplary KPI alert system architecture, in accordance with an embodiment of the present invention;

FIG. 3 is a block/flow diagram of an exemplary first method of targeted KPI impact alerting involving inferring effective reporting hierarchy, in accordance with an embodiment of the present invention;

FIG. 4 is a block/flow diagram of an exemplary email chain pertaining to an IT incident, in accordance with an embodiment of the present invention;

FIG. 5 is a block/flow diagram of an exemplary reporting hierarchy that is generated from the email chain of the IT incident of FIG. 4, in accordance with an embodiment of the present invention;

FIG. 6 is a block/flow diagram of an exemplary second method of targeted KPI impact alerting involving identifying relevant KPIs and order level interests of each individual, in accordance with an embodiment of the present invention;

FIG. 7 is a block diagram of an exemplary third method of targeted KPI impact alerting involving identifying appropriate users to notify, in accordance with an embodiment of the present invention; and

FIG. 8 is a block diagram of an exemplary computer system applied to the KPI alert system architecture of FIG. 2, in accordance with an embodiment of the present invention.

Throughout the drawings, same or similar reference numerals represent the same or similar elements.

### DETAILED DESCRIPTION

Embodiments in accordance with the present invention advantageously provide targeted key performance indicator (KPI) impact alerts. System performance management in a computing system has traditionally been based on collection of data from multiple sources, which are then processed and presented to system administrators for analysis. Depending on the complexity of the system, different levels of aggregation, threshold detection, pattern recognition, etc., are applied to the data before the data is presented for analysis. Such complex computing systems may generate thousands of dynamic performance metrics in the form of key performance indicators (KPI's) with time-varying values, which makes it challenging to manage the metrics manually. In this regard, automatic alerts may be used that are based on predetermined thresholds or rule sets that indicate a malfunction when triggered.

However, configuration of these rules for alerts, whether static or dynamic, is often difficult in that it may involve expertise in two separate disciplines. In particular, it requires a deep understanding of the relevant technology domain generally associated with a domain expert, and also mathematical skills generally associated with a data scientist, who provides the set of tools and/or algorithms to automate the collection, filtering, and analysis of the data. For example, a domain expert may be proficient in the relevant technology and the interrelationships between the various components of the monitored system. However, the domain expert may not be familiar with the tools and algorithms to automatically gather, filter, and analyze the vast amount of KPI's generated by a complex system. Indeed, such analysis is usually the realm of the data scientist, who may not have a deep understanding of the relevant technology and the interrelationships between the various components of the system.

While tool developers may use traditional approaches to find a compromise between domain experts and data scientists to provide customized solutions for defining and/or updating system alerts, such tight coordination between the two principles generally does not allow a quick turn-around time and usually results in the sub-optimal performance of the system.

Accordingly, it would be beneficial to have an automated and efficient way of sending alerts to the appropriate individual within an organization. The exemplary embodiments of the present invention advantageously identify KPIs and map them based on user hierarchy within the organization. The exemplary method can advantageously identify the effective reporting hierarchy of both business and IT persona using corporate data. The exemplary system can also advantageously learn the relevant KPIs and orders for each persona over a period of time from the inferred effective reporting hierarchy, current user communications, their likes and dislikes, collectively resulting in an interest-persona map. The exemplary method and system can further advantageously identify appropriate users to notify using the interest-persona map, duration and severity of the impact, impacted orders and their scope, as well as impacted KPIs with lineage and scope. Thus, in case of an outage or anomaly or error message, the system architecture advantageously automatically knows who to notify to quickly and efficiently resolve the KPI impact.

It is to be understood that the present invention will be described in terms of a given illustrative architecture; however, other architectures, structures, substrate materials and process features and steps/blocks can be varied within the scope of the present invention. It should be noted that certain features cannot be shown in all figures for the sake of clarity. This is not intended to be interpreted as a limitation of any particular embodiment, or illustration, or scope of the claims.

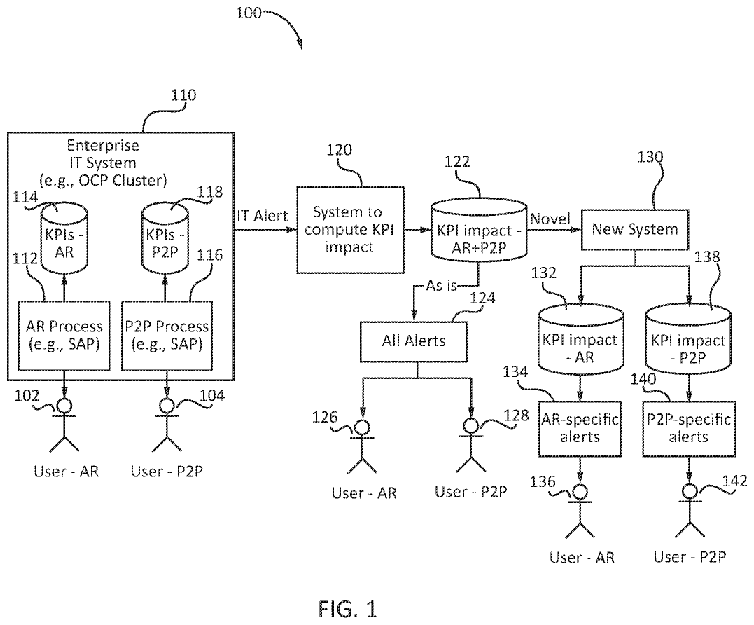

FIG. 1 is a block/flow diagram providing a comparison between conventional key performance indicator (KPI) systems and the exemplary targeted KPI impact alert system, in accordance with an embodiment of the present invention.

The context-aware alerting system 100 illustrates a first user 102 and a second user 104 interacting with an enterprise IT system 110. The first user 102 can be an accounts receivable (AR) user, whereas the second user 104 can be a purchase-to-pay (P2P) user. The first user 102 communicates with an AR process 112, which includes KPIs 114 related to AR. The second user 104 communicates with a P2P process 116, which includes KPIs 118 related to P2P. The enterprise IT system 110 can be, for example, an OpenShift Container Platform (OCP) cluster. OCP brings together Docker and Kubernetes, and provides an API to manage these services. OCP further allows a user to create and manage containers.

The enterprise IT system 110 sends IT alerts to a system 120 which computes the KPI impact. The system 120 then provides such information to a AR+P2P component 122.

In conventional systems, all the alerts 124 are sent to all the AR users 126 and to all the P2P users 128. Therefore, an alert storm is generated as all the users receive all the alerts. The users are thus bombarded with alerts that are irrelevant to them.

In the exemplary system 130, an AR-KPI impact component 132 sends AR-specific alerts 134 to targeted AR users 136. Further, a P2P-KPI impact component 138 sends P2P-specific alerts 140 to targeted P2P users 142.

Therefore, the exemplary system advantageously does not create an alert storm. Instead, the exemplary system advantageously matches specific alerts with specific and relevant users. In other words, the alerts are targeted alerts that are directed to certain relevant individuals only. These are user-targeted KPI alerts. As a result, AR users 136 do not receive P2P-specific alerts 140. Similarly, P2P users 142 do not receive AR-specific alerts 134. Alerts are advantageously forwarded only to the appropriate or relevant or applicable or pertinent individuals within an organization or corporation. The KPIs can be extracted from any type of business process.

A business process is a set of related, structured activities and steps performed by individuals or equipment within an organization to achieve the organization's basic objectives, like profit maximization and customer satisfaction. Business processes can be repeated at all organizational levels and may or may not be visible to customers. Stated differently, a business process is an activity or set of activities that accomplish a specific organizational goal. Business processes should have purposeful goals, be as specific as possible and produce consistent outcomes. To measure the success of a business process, organizations track the completion of different steps within the process, that is, benchmarks or evaluate the quality of the process endpoint. The business process can be any business process contemplated by one skilled in the art that generates KPIs.

Business processes can include, and are not limited to, a human resource process, a project management process, a social media management process, a customer service process, a marketing process, a product development process, a delivery management system process, an onboarding process, a sales process, a budgeting process, a procurement process, a content promotion process, and an asset management process.

Regarding a human resource process, establishing business processes for hiring new employees can help companies attract and retain qualified professionals. Following a defined set of protocols during the hiring process can help companies hire candidates who can make a difference to their bottom line. Automated hiring tools can speed up the hiring process and save a lot of time HR professionals would spend on screening candidates. These hiring tools can search for keywords in each application that help shortlist suitable candidates for a job role. Automating the human resources processes can ensure faster and cost-efficient hiring. The context-aware alerting system 100 can be applied to the human resource process.

Regarding a project management process, many companies use project management systems to streamline the project workflow and keep track of the project's timeline. Companies can opt for a proprietary process or companies may use project management software. Most of the project management software can automate the workflow. Most of these automation tools provide a dashboard that displays the activities and tasks of every project member. From initiation and project planning to execution, monitoring and completion, project management software can streamline the project workflow. This can help to complete a business project effectively and efficiently. The context-aware alerting system 100 can be applied to the project management process.

Regarding a social media management process, having a dedicated business account on social media platforms is important and beneficial for growing a business. While operating social media accounts on different platforms is challenging, it is essential for companies to frequently post new updates to grow consumer awareness. Using various social media management software, companies can schedule posts and keep track of the important metrics. Bringing automation can streamline social media presence and ensure companies can grow a loyal base of followers. The context-aware alerting system 100 can be applied to the social media management process.

Regarding a marketing process, such process includes designing, developing and launching a new product to market. As a result, companies use marketing tools to streamline their processes. By automating a marketing process, companies can align their goals and efforts. Enabling a business process in the marketing department can help in generating more leads and increasing sales. As automation enables a company to increase its conversion rate, it helps manage leads more efficiently. The context-aware alerting system 100 can be applied to the marketing process.

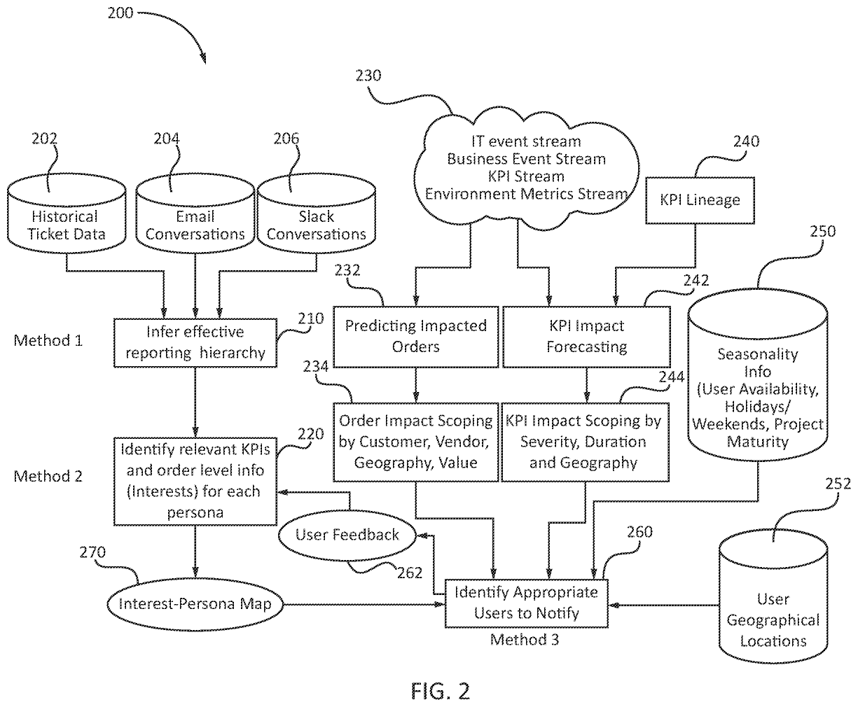

FIG. 2 is a block/flow diagram of an exemplary KPI alert system architecture, in accordance with an embodiment of the present invention.

The KPI alert system architecture 200 advantageously illustrates three methodologies for collectively performing KPI alerting. Historical ticket data 202, email conversations 204, and Slack conversations 206 are fed into a reporting hierarchy component 210. The reporting hierarchy component 210 is part of methodology 1. Ticketing data relates to IT tickets. The word “ticket” commonly refers to a piece of work slated to be done by an IT support team, that is, tasks such as bug fixes and other user requests, or any other operation in the technology environment. Applying this usage to the customer service environment, any customer issue or request generates a “ticket” that is tracked into a system all along its life cycle. For example, submission of a request by the client, creation of a support ticket shared to the customer and the representative, assignment of the ticket to a dedicated representative, sending status to other departments, and resolution of the request and closing the case.

A ticketing system is a tool that monitors and documents customer interaction with customer service representatives and helps efficiently manage the flow of incoming contacts, whether from consumer sites, social media, or online forums. The system processes and catalogs different requests, tracing the progression of each case from customer request to solution and closing.

When a ticket is created, the ticket is assigned to a customer service representative. This representative starts working on the ticket and keeps the customer informed. The customer can also reach out at any time to customer service using that same ticket. The relevant representative receives a notification and is able to reply immediately.

Once a case is closed, it remains archived in the system, so repetitive requests can be utilized to generate frequently asked questions (FAQs), or forum responses via a company representative, enabling customers to find an immediate answer whenever one is required, without needing direct support.

After a reporting hierarchy is determined, relevant KPIs can be identified and order level information (interests) for each person can further be identified in a KPI identification component 220. The KPI identification component 220 is part of methodology 2.

Data streams 230 are fed into components 232 and 242. Component 232 allows for predicting impacted orders, whereas component 242 allows for KPI impact forecasting. The data streams 230 can be, e.g., IT event streams, business event streams, KPI streams, and environment metrics streams. The predicted impacted orders of component 232 are fed into an order impact scoping component 234, whereas the KPI impact forecasting of component 242 are fed into a KPI impact scoping component 244. Component 242 also receives KPI lineage 240. The IT event streams, business event streams, KPI streams, and environment metrics streams are analyzed for context, based on the language found within such communications. This can be referred to as contextual communication analysis. Communication contexts include intrapersonal, interpersonal, group, public, and mass communications. In the instant case, team-based communications are primarily analyzed for context to determine or extract key words or key phrases to generate a reporting hierarchy based on that contextual communication.

The order impact scoping component 234 can determine order impact scoping by customer, vendor, geography, and/or value. The KPI impact scoping component 244 can determine KPI impact scoping by severity, duration, and/or geography. The results of the order impact scoping component 234 and the KPI impact scoping component 244 are fed into a notification component 260. The notification component 260 identifies appropriate users or people within an organization to notify. The notification component 260 is part of methodology 3. The notification component 260 is fed with data from component 250 and the data from component 252. Component 250 includes seasonality information. Seasonality information can include, for example, user availability, holidays, weekends, project maturity, etc. Component 252 includes, e.g., user geographical locations.

The notification component 260 can trigger user feedback 262. For example, the user feedback 262 can include users informing the system whether or not they were the appropriate or applicable or pertinent person to receive the KPI alert. A user A can inform the system that the received KPI notification was not appropriate to that user because that user is not involved with that specific stage of a process. Alternatively, user B can inform the system that the received KPI notification was appropriate as user B is in charge of the department that handles such issues.

Based on all this processing, a person interest map 270 can be advantageously generated or created. The person interest map 270 can be illustrated as a network with nodes (vertices) and edges. Each person within this network can be associated with specific types of KPIs or KPI alerts. For example, KPIs or KPI alerts related to finance can be forwarded to certain individuals within the finance department. KPIs or KPI alerts related to sales can be forwarded to certain individuals within the sales department. KPIs or KPI alerts related to marketing can be forwarded to certain individuals within the marketing department. KPIs or KPI alerts related to operations management can be forwarded to certain individuals within the operations management department. KPIs or KPI alerts related to computers and information technology can be forwarded to certain individuals within the IT department.

Moreover, not everyone within the department will receive such KPI alerts. For instance, regarding the IT department, there could be five different individuals that work within this department full time. A first IT person can be designated to receive KPI alerts regarding one issue. A second IT person can be designated to receive KPI alerts regarding another issue. A third IT person can be designated not to receive any KPI alerts. Therefore, a KPI alert associated with the IT department is not blindly or randomly sent to every single individual within the IT department. Instead, KPI alerts are targeted toward departments, as well as to people within those departments. As one can imagine, not everyone within a department needs to be alerted of a specific KPI alert.

In one instance, the person interest map 270 can be generated by the organization itself. In another instance, the person interest map 270 can be advantageously generated automatically by the KPI alert system architecture 200. The KPI alert system architecture 200 can advantageously analyze email communications within an organization to determine which individuals receive which KPIs alerts. For example, if 4 individuals constantly communicate regarding a specific topic, then the KPI alert system architecture 200 can send specific KPI alerts to such individuals based on their communication topics and communication language or texts. A person interest map 270 is not only department based. A person interest map 270 can advantageously span with people from multiple departments. A person interest map 270 can be formed by individuals in different departments working together on a common project (e.g., engineering, meeting, sales, etc.).

Therefore, according to the KPI alert system architecture 200, business users do not need to manually set the KPI alert notifications that are relevant to them. Thus, employees within the organization will not be flooded with irrelevant or inapplicable alerts. The KPI alert system architecture 200 advantageously automatically creates or generates forecasted KPI impact alerts that are directed to specific or targeted people within the organization or corporation. The KPI alert system architecture 200 advantageously identifies the KPI and maps it with the persona, thus providing an intelligent way to identify stakeholders who may have multiple projects in their pipeline.

By using corporate data, such as, tickets or emails or enterprise chat messages, instant messaging, job profiles, and the nature of an impact of current anomalies, the exemplary methods and systems advantageously identify the relevant KPIs and orders and map them with business and IT persona or users by considering at least the following information, personalized, contextualized, seasonality, and availability of the person, streaming data including IT events, environmental events, business events, and KPIs, dynamic KPI impact information in the form of alerts, and KPI lineage information. Job profiles can include at least roles, interests, availability, geography, and seasonality. The nature of the impact is based on the duration and magnitude of the forecasted impacts.

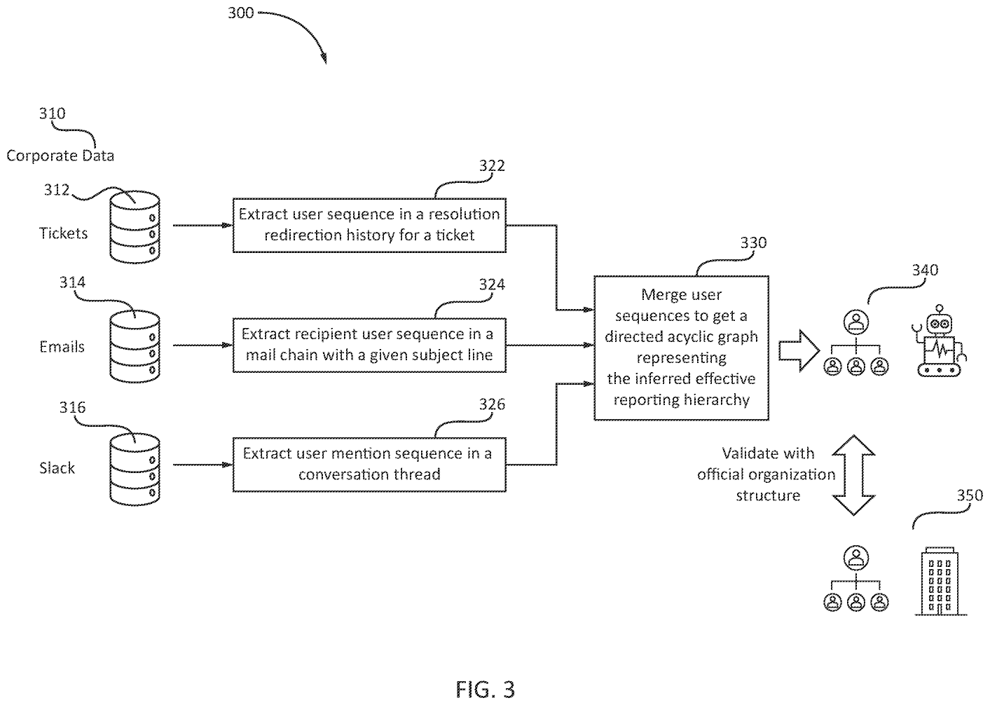

FIG. 3 is a block/flow diagram of an exemplary first method of targeted KPI impact alerting involving inferring effective reporting hierarchy, in accordance with an embodiment of the present invention.

Regarding the first method, diagram 300 shows corporate data 310, such as, tickets 312, emails 314, and Slack communications 316. Slack is an instant messaging program. Users can communicate with voice calls, video calls, text messaging, media, and files and private chats or as part of communities referred to as workspaces.

The tickets 312 are sent to component 322 where user sequences are extracted in a resolution redirection history for a ticket.

The emails 314 are sent to component 324 where recipient user sequences are extracted in a mail chain with a given subject line.

The Slack communications 316 are sent to component 326 where user mention sequences are extracted in a conversation thread.

The data from the components 322, 324, and 326 are sent to the component 330 where user sequences are merged to obtain a directed acyclic graph representing the inferred effective reporting hierarchy. The directed acyclic graph is designated as 340. The generated directed acyclic graph 340 can be validated or cross-checked with an official organization structure 350.

Therefore, the KPI alert system architecture 200 can advantageously automatically generate a plurality of directed acyclic graphs. The automatically generated acyclic graphs can be advantageously compared to one or more organizational structures or organizational graphs. The comparison can be made in order to verify an accurate reporting hierarchy. As a result, one or more managers will not be reporting to lower level employees. Each vertex in the acyclic graph represents a person working for the organization. Various edges can be created between the vertices in the acyclic graph based on communications between people represented in the vertices.

KPI alerts can be topic specific, or can be day specific, or can be time specific, etc., or a combination thereof. Certain KPI alerts can be sent to one individual on a Monday and can be sent to a different individual on a Friday. Certain KPI alerts can be sent in the morning and certain KPI alerts can be sent in the evening based on various criteria or variables or parameters. KPI alerts can be sent to different individuals based on different circumstances, for example, based on vacation schedules or conference schedules (seasonality). An individual may receive certain KPI alerts throughout the year, except for a two week period in the summer when that individual is on vacation. Those KPI alerts are sent, instead to another individual filling in for the person on vacation. As a result, personal schedules can be taken into account when creating or generating the reporting hierarchy.

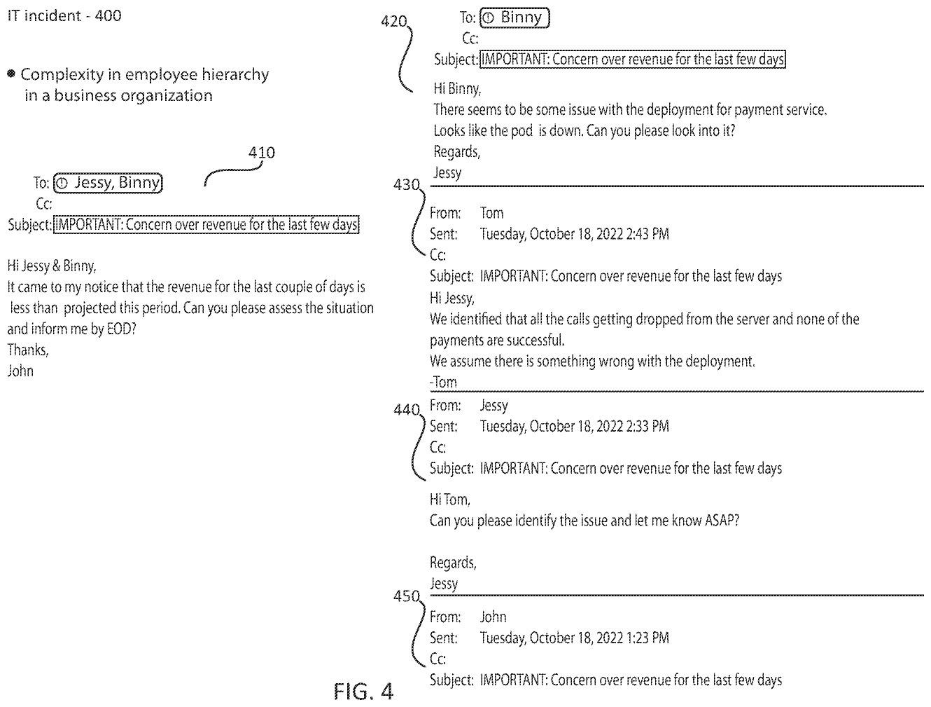

FIG. 4 is a block/flow diagram of an exemplary email chain pertaining to an IT incident, in accordance with an embodiment of the present invention.

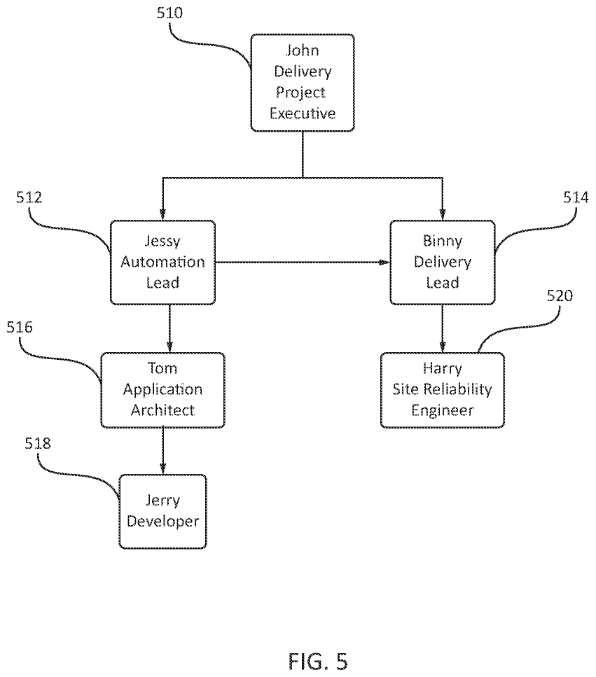

The IT incident 400 illustrates communications between individuals within a business organization. An email 410 can be sent from John to Jessy and Binny. An email 420 can be sent from Jessy to Binny. An email 430 can be sent from Tom to Jessy. An email 440 can be sent to Tom from Jessy. An email 450 can be sent from Jessy to Tom. The email communication or email chain refers to an IT incident 400 that may relate to the deployment of a payment service. Based on these communications within this email chain, the KPI alert system architecture 200 can automatically generate a reporting hierarchy, as discussed below in detail with reference to FIG. 5.

FIG. 5 is a block/flow diagram of an exemplary reporting hierarchy that is generated from the email chain of the IT incident of FIG. 4, in accordance with an embodiment of the present invention.

The reporting structure or reporting hierarchy can be as follows:

At the top vertex 510 is John. John can be the delivery project executive. Below John are two vertices, vertex 512 representing Jessy and vertices 514 representing Binny. Jessy can be the automation lead, whereas Binny can be the delivery lead. An arrow is also present between Jessy and Binny indicating that they are at the same level. Under Jessy, there are two more vertices. Vertex 516 representing Tom and vertex 518 representing Jerry. Tom can be an application architect, whereas Jerry can be a developer. Under Binny, there is one more vertex. It is vertex 520 representing Harry who is a site reliability engineer.

This reporting structure does not exist in the company directory. Instead, this reporting structure was advantageously automatically generated by the KPI alert system architecture 200 based on the communications between these individuals for resolving an IT issue. As a result, various communications between individuals of an organization can be used to automatically generate targeted reporting structures to determine exactly where to send KPI specific alerts. Stakeholders are identified from the email chains. In this instance, any software related failures can be addressed to Jessy and his team, whereas any deployment related issues will be taken care of by Binny and his team. John is clearly responsible for the overall product delivery. Thus, KPIs related to the process or the product should be delivered to John. Any performance or software related KPIs should be communicated to Jessy, Tom, and Jerry. Any deployment related issues should be notified to Binny and Harry. When an issue persists for more than a few days or if the ticket volume is very high, then the issue can be escalated back to John. As can be seen, various types of information can be gained from inferred effective reporting hierarchies.

These reporting structures can advantageously expire after a certain period of time. By expiring, it is meant that the reporting structures can be deleted or ignored. For example, if John knows that this project needs to be completed by October 1, then John can designate such deadline to the KPI alert system architecture 200 which can automatically stop creating or generating new reporting hierarchies based on the communication between such individuals. Therefore, reporting structures can have expiration dates. Additionally, reporting structures can be modified by the individuals within the email communication chain. In this instance, John can determine that another individual should be receiving KPI alerts based on this email communication. As such, John can add that individual to the generated reporting hierarchy or generated reporting structure manually. Individuals within the reporting structures can thus add or remove vertices (e.g., people) based on their experience on who should receive or not receive KPI alerts.

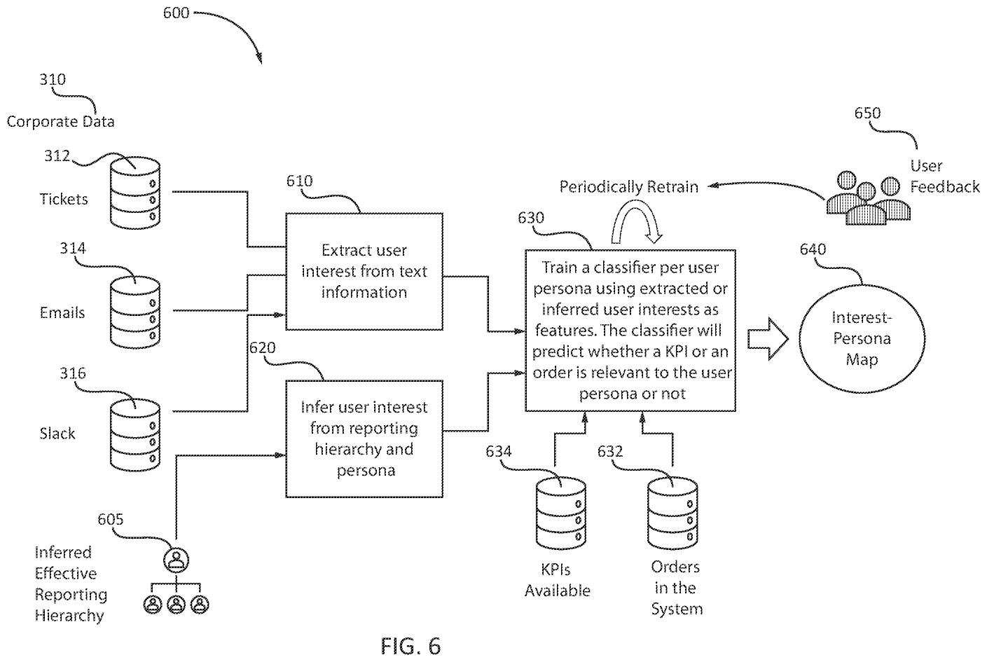

FIG. 6 is a block/flow diagram of an exemplary second method of targeted KPI impact alerting involving identifying relevant KPIs and order level interests of each individual, in accordance with an embodiment of the present invention.

Regarding the second method, diagram 600 shows corporate data 310, such as, tickets 312, emails 314, and Slack communications 316. As noted above, Slack is an instant messaging program. Users can communicate with voice calls, video calls, text messaging, media, and files and private chats or as part of communities referred to as workspaces.

The tickets 312, the emails 314, and the Slack communications 316 are sent to component 610 where user interests are extracted from text information. Inferred or generated reporting structures 605 are fed into component 620 where user interests are inferred from reporting hierarchy and persona. The data from components 610 and 620 are fed into component 630 where the classifier is trained per user persona by using extracted or inferred user interests as features. The classifier advantageously predicts whether a KPI or an order is relevant to the user persona or not. The component 630 is also fed with available KPIs 634 and with system orders 632. The output of component 630 is an interest-persona map 640. User feedback 650 can be sent back to the classifier in order to retrain and update the classifier.

The classifier can be a machine learning algorithm used to assign a class label to a data input. A classifier can also be a formula or a technique that can assign a class label to any given point in a feature space. The classifier can be a specialized or customized classifier, referred to as a KPI classifier. The KPI classifier can only label indicators established within an organization. In one example, the KPI classifier can be an artificial intelligence (AI) classifier.

Therefore, the interest-persona map 640 can be advantageously generated based on text information found in communications between individuals within an organization and from prior generated reported hierarchies. For example, if a user is interested in a particular KPI or order, then the user's manager will be interested in the same or a higher order of KPI or a superset of orders. Users with the same persona will be interested in the same KPI or order.

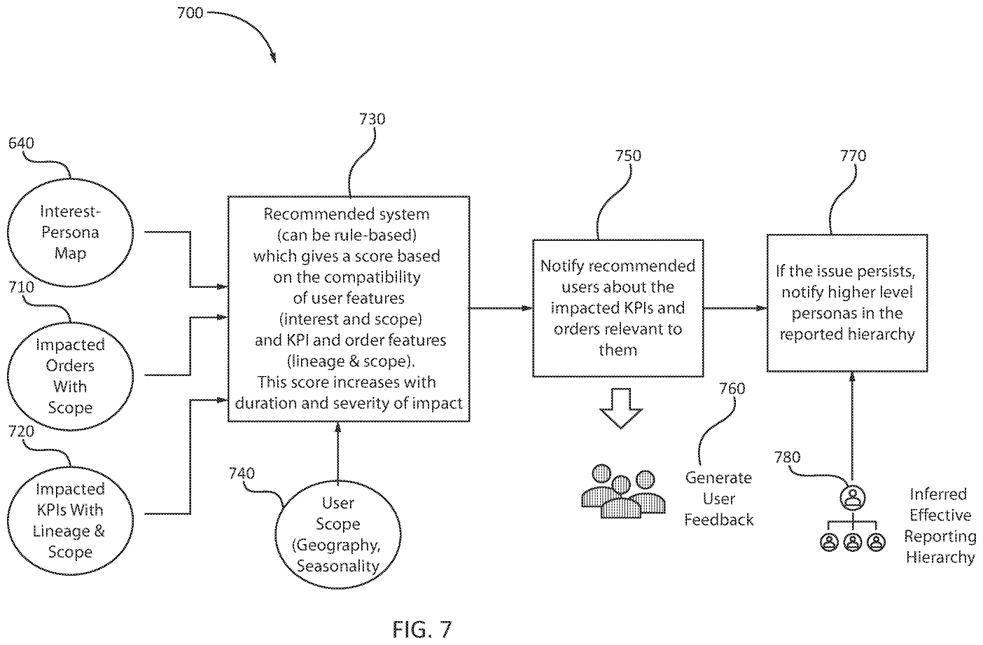

FIG. 7 is a block diagram of an exemplary third method of targeted KPI impact alerting involving identifying appropriate users to notify, in accordance with an embodiment of the present invention.

Regarding the third method, diagram 700 shows the interest-persona map 640, the impacted orders with scope 710, and the impact of KPIs with lineage and scope 720 fed into component 730. Component 730 represents a recommended system (e.g., rule-based) which gives or provides or generates a score based on the compatibility of user features (interest and scope) and KPI and order features (lineage and scope). The score increases with duration and severity of KPI impact. Component 730 also receives user scope 740. The user scope 740 can refer to geography or seasonality, etc. The output of component 730 can be provided to a first notification unit 750, which notifies recommended users regarding the impacted KPIs and orders relevant to them. If the issue persists, then a second notification unit 770 can advantageously notify higher level personas and the reported hierarchy. Throughout this process, user feedback 760 can be generated. Regarding the notification of higher level personas, an inferred effective reporting hierarchy 780 can be advantageously consulted to make a decision.

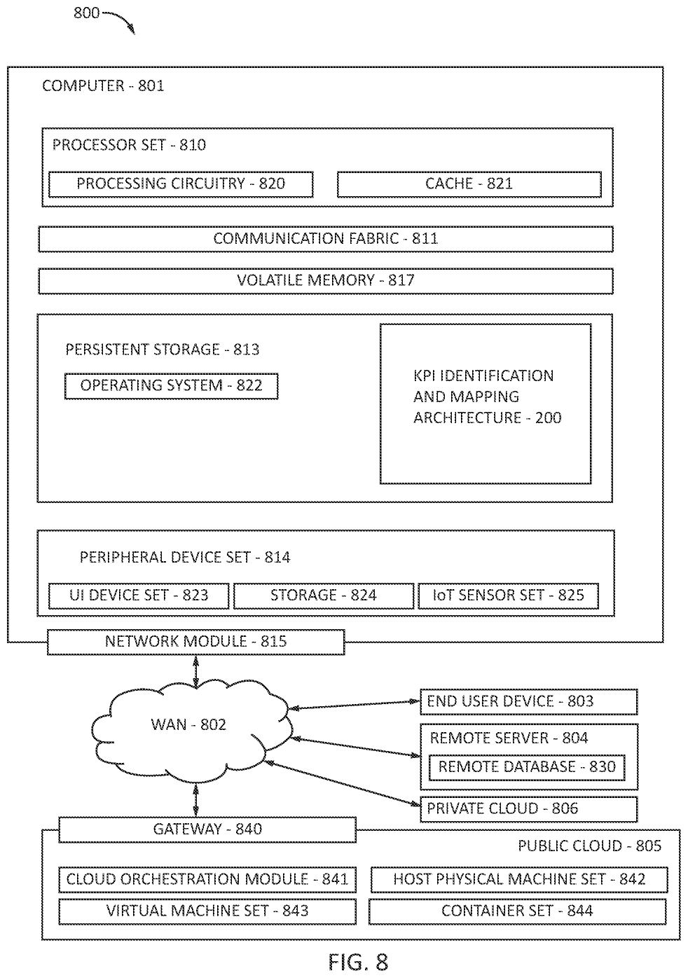

FIG. 8 is a block diagram of an exemplary computer system applied to the KPI alert system architecture of FIG. 2, in accordance with an embodiment of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is usually moved at some occasional points in time during normal operations of a storage device, such as during access, de-fragmentation or garbage collection, but this does not render the storage device as transitory because the data is not transitory while it is stored.

Computing environment 800 contains an example of an environment for the execution of at least some of the computer code involved in performing the inventive methods, such as the KPI alert system architecture 200. In addition to block 850, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and block 850, as identified above), peripheral device set 814 (including user interface (UI) device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

COMPUTER 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically computer 801, to keep the presentation as simple as possible. Computer 801 may be located in a cloud, even though it is not shown in a cloud in FIG. 8. On the other hand, computer 801 is not required to be in a cloud except to any extent as may be affirmatively indicated.

PROCESSOR SET 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located “off chip.” In some computing environments, processor set 810 may be designed for working with qubits and performing quantum computing.

Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods may be stored in block 850 in persistent storage 813.

COMMUNICATION FABRIC 811 is the signal conduction path that allows the various components of computer 801 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 812 is any type of volatile memory now known or to be developed in the future. Examples include dynamic type random access memory (RAM) or static type RAM. Typically, volatile memory 812 is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801.

PERSISTENT STORAGE 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid state storage devices. Operating system 822 may take several forms, such as various known proprietary operating systems or open source Portable Operating System Interface-type operating systems that employ a kernel. The code included in block 850 typically includes at least some of the computer code involved in performing the inventive methods.

PERIPHERAL DEVICE SET 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In some embodiments, storage 824 may take the form of a quantum computing storage device for storing data in the form of qubits. In embodiments where computer 801 is required to have a large amount of storage (for example, where computer 801 locally stores and manages a large database) then this storage may be provided by peripheral storage devices designed for storing very large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

NETWORK MODULE 815 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices. Computer readable program instructions for performing the inventive methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, the WAN 802 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 803 is any computer system that is used and controlled by an end user (for example, a customer of an enterprise that operates computer 801), and may take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 may be a client device, such as thin client, heavy client, mainframe computer, desktop computer and so on.

REMOTE SERVER 804 is any computer system that serves at least some data and/or functionality to computer 801. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804.

PUBLIC CLOUD 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

In conclusion, regarding FIGS. 1-8, a system and method to present or display forecasted KPI impacts is provided. The exemplary method can advantageously identify the effective reporting hierarchy of both business and IT persona using corporate data. The exemplary system can also advantageously learn the relevant KPIs and orders for each persona over a period of time from the inferred effective reporting hierarchy, current user communications, their likes and dislikes, collectively resulting in an interest-persona map. The exemplary method and system can further advantageously identify appropriate users to notify using the interest-persona map, duration and severity of the impact, impacted orders and their scope, as well as impacted KPIs with lineage and scope. By using corporate data, such as, tickets or emails or enterprise chat messages, instant messages, job profiles, and the nature of an impact of current anomalies, the exemplary methods and systems advantageously identify the relevant KPIs and orders and map them with business and IT persona or users by considering at least the following information, personalized, contextualized, seasonal, and availability of the person, streaming data including IT events, environmental events, business events, and KPIs, dynamic KPI impact information in the form of alerts, and KPI lineage information.

The advantages of the present invention include providing targeted or focused KPI impact alerts to specific or targeted or appropriate users within the business or organization. One of the most important aspects of a business has always been KPIs. Without KPIs, a company runs the danger of losing business due to unpredictable performance or management issues. An important factor in enabling managers and members of the team to stay on track to meet and exceed the company's goals and objectives is selecting the right KPIs and linking such KPIs quickly and effectively to the appropriate users within the organization. Effective and targeted KPI reporting to appropriate users is important because it provides an explicit and accurate picture of a business's performance, well-being, and growth potential. Using several specific KPIs and forwarding specific KPI alerts to appropriate users is a far better solution for measuring business growth and success than simply basing it on one measurement, such as annual revenue.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor-or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It is also noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments of methods and devices for targeted key performance indicator (KPI) impact alerts (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A method comprising:
employing corporate data to generate an acyclic graph representing a reporting hierarchy;
identifying relevant key performance indicators (KPIs) for a plurality of users;
training a classifier to predict whether a KPI is relevant to a user of the plurality of users;
generating interest-persona maps correlating KPI impact alerts with a subset of the plurality of users based on detected information technology (IT) event streams, business streams, KPI streams, and environmental metrics streams;
assigning a score to each KPI impact alert based on compatibility between user features and KPI features; and
notifying, by consulting the interest-persona maps, one or more targeted users of the KPI impact alerts relevant to them.

2. The method of claim 1, wherein the corporate data includes at least IT tickets, emails from an email communication program, and instant messages from an instant messaging communication program between the plurality of users of a corporation.

3. The method of claim 2, wherein a user sequence is extracted from the IT tickets.

4. The method of claim 3, wherein a recipient user sequence is extracted from the emails having an email chain with a same or related subject line.

5. The method of claim 4, wherein a user mention sequence is extracted from the instant messages having a common conversation thread.

6. The method of claim 5, wherein the user sequence, the recipient user sequence, and the user mention sequence are merged to generate the acyclic graph representing the reporting hierarchy.

7. The method of claim 1, wherein the acyclic graph representing the reporting hierarchy is compared with an existing organization chart for job profile consistency.

8. The method of claim 1, wherein the score of each KPI impact alert increases with duration and severity of KPI impact.

9. The method of claim 1, wherein the one or more targeted users are notified based on seasonality information.

10. The method of claim 1, wherein the one or more targeted users are notified based geographical locations.

11. A computer program product for implementing a key performance indicator (KPI) identification and mapping system, the computer program product comprising a computer readable storage medium having program instructions embodied therewith, the program instructions executable by a computer to cause the computer to:
employ corporate data to generate an acyclic graph representing a reporting hierarchy;
identify relevant key performance indicators (KPIs) for a plurality of users;
train a classifier to predict whether a KPI is relevant to a user of the plurality of users;
generate interest-persona maps correlating KPI impact alerts with a subset of the plurality of users based on detected information technology (IT) event streams, business streams, KPI streams, and environmental metrics streams;
assign a score to each KPI impact alert based on compatibility between user features and KPI features; and
notify, by consulting the interest-persona maps, one or more targeted users of the KPI impact alerts relevant to them.

12. The computer program product of claim 11, wherein the corporate data includes at least IT tickets, emails from an email communication program, and instant messages from an instant messaging communication program between the plurality of users of a corporation.

13. The computer program product of claim 12, wherein a user sequence is extracted from the IT tickets.

14. The computer program product of claim 13, wherein a recipient user sequence is extracted from the emails having an email chain with a same or related subject line.

15. The computer program product of claim 14, wherein a user mention sequence is extracted from the instant messages having a common conversation thread.

16. The computer program product of claim 15, wherein the user sequence, the recipient user sequence, and the user mention sequence are merged to generate the acyclic graph representing the reporting hierarchy.

17. The computer program product of claim 11, wherein the acyclic graph representing the reporting hierarchy is compared with an existing organization chart for job profile consistency.

18. The computer program product of claim 11, wherein the score of each KPI impact alert increases with duration and severity of KPI impact.

19. A system for implementing a key performance indicator (KPI) identification and mapping architecture, the system comprising:
a memory; and
one or more processors in communication with the memory configured to:
employ corporate data to generate an acyclic graph representing a reporting hierarchy;
identify relevant key performance indicators (KPIs) for a plurality of users;
train a classifier to predict whether a KPI is relevant to a user of the plurality of users;
generate interest-persona maps correlating KPI impact alerts with a subset of the plurality of users based on detected information technology (IT) event streams, business streams, KPI streams, and environmental metrics streams;
assign a score to each KPI impact alert based on compatibility between user features and KPI features; and
notify, by consulting the interest-persona maps, one or more targeted users of the KPI impact alerts relevant to them.

20. The system of claim 19, wherein the corporate data includes at least IT tickets, emails from an email communication program, and instant messages from an instant messaging communication program between the plurality of users of a corporation.
